(19) United States
(12) Patent Application Publication
(10) Pub. No.: US 2024/0387915 A1
(43) Pub. Date: Nov. 21, 2024

(54) STACKABLE BATTERY

(71) Applicants: HYUNDAI MOTOR COMPANY, Seoul (KR); KIA CORPORATION, Seoul (KR)

(72) Inventors: Gun Woo Ko, Seongnam-si (KR); Se Gi Kang, Gunpo-si (KR); Gyung Hoon Shin, Seoul (KR); Jong Wook Lee, Cheonan-si (KR)

(73) Assignees: HYUNDAI MOTOR COMPANY, Seoul (KR); KIA CORPORATION, Seoul (KR)

(21) Appl. No.: 18/508,836

(22) Filed: Nov. 14, 2023

(30) Foreign Application Priority Data
May 15, 2023 (KR) 10-2023-0062516

(51) Int. Cl. H01M 50/209; H01M 50/244; H01M 50/249

(52) U.S. Cl. CPC H01M 50/209; H01M 50/244; H01M 50/249; H01M 2220/20

(57) ABSTRACT

A stackable battery includes: a plurality of battery cases, each including a battery module therein, and stacked in a height direction of a vehicle; and a plurality of through-pipes provided in each battery case and configured to pass through the battery case in a vertical direction. The through-pipes are in the shape of pipes extending in the vertical direction and are provided in each battery case arranged together in the vertical direction. The stackable battery further includes at least one support member passing through the plurality of through-pipes in the vertical direction and supporting an upper battery case among the plurality of battery cases.

### CROSS REFERENCE TO RELATED APPLICATION

The present application claims priority to Korean Patent Application No. 10-2023-0062516, filed on May 15, 2023, the entire contents of which are incorporated herein by reference.

### BACKGROUND

### Field

The present disclosure relates to a battery which is vertically stackable.

### Description of the Related Art

In light of the growing concern over carbon emissions resulting from the utilization of petroleum-based energy sources as a significant driver of climate change, ongoing research is focused on developing technologies for environmentally friendly energy usage aimed at carbon emission reduction. In particular, in the field of automobiles, there is a notable emphasis on hydrogen fuel cell-powered vehicles and vehicles equipped with lithium-ion secondary batteries, both garnering significant attention.

Since an electric vehicle powered by a lithium-ion secondary battery allows for extended driving distances on a single charge, drivers can experience enhanced psychological comfort, and they have the flexibility to choose between long-distance and short-distance trips. This provides a wider range of possibilities for extended journeys.

To enhance the single-trip range of an electric vehicle, diverse approaches are under consideration, including modifying the secondary battery's material, enhancing the performance of a motor, and reducing the weight of the vehicle.

The statements in this section merely provide background information related to the present disclosure and may not constitute prior art.

### SUMMARY

The present disclosure provides a stackable battery with increased capacity achieved by incorporating a stackable battery case.

The stackable battery according to the present disclosure to achieve the foregoing goals includes components described below.

A stackable battery includes a plurality of battery cases, each including a battery module therein and stacked in a height direction of a vehicle. The stackable battery further includes a plurality of through-pipes provided in each battery case and allowing the battery case to pass therethrough in a vertical direction. The through-pipes are in the shape of pipes extending in the vertical direction inside being penetrated together by being the battery case, the through-pipes provided in each battery case arranged together in the vertical direction; and a support member passing through the plurality of through-pipes in the vertical direction and supporting an upper battery case.

The support member may have a shape of a pipe extending in the vertical direction and include, at a point thereof, a seating surface extending in a circumferential direction on which an upper end surface or a lower end surface of the through-pipe is seated.

The stackable battery may further include an engaging member engaging the plurality of battery cases by passing through the plurality of through-pipes and the support member and a finishing bolt inserted from an upper end of the through-pipe provided on top and coupled to the engaging member.

On an outer surface of the battery case provided at bottom among the plurality of battery cases, a mounting portion for coupling a vehicle body with the battery case may be formed.

The stackable battery may further include a side binding member attached to a side surface of the plurality of battery cases to bind the plurality of battery cases and a front-rear binding member attached to a front surface and a rear surface of the plurality of battery cases to bind the plurality of battery cases.

The side binding member may include a first binding member having formed therein an inserting surface with a surface extending in the width direction of the battery case, the inserting surface inserted between the plurality of adjacent battery cases, and a bent surface formed to be bent downward at an end of the inserting surface, the bent surface contacting a side surface of the battery case and a second binding member having a shape extending in the vertical direction and having a surface surrounding a bent surface on a side surface of the first binding member and the other surface contacting a side surface of the battery case positioned on the insertion surface.

The front-rear binding member may include a front binding member coupled to a front surface of the plurality of battery cases and a rear binding member coupled to a rear surface of the plurality of battery cases.

The plurality of battery cases may include a first battery case positioned in a relatively lower portion and a second battery case positioned in a relatively upper portion.

With the stackable battery according to the present disclosure, as it is easy to disassemble and assemble the battery cases, the battery with the increased capacity may be provided through the stackable battery cases, thereby improving a driving distance of an electric vehicle, etc.

### BRIEF DESCRIPTION OF THE DRAWINGS

In order that the disclosure may be well understood, there will now be described various forms thereof, given by way of example, reference being made to the accompanying drawings, in which:

FIG. 1 is a stackable battery according to an embodiment of the present disclosure;

FIG. 2 shows assembly of a through-pipe, a support member, and so forth, according to an embodiment of the present disclosure;

FIG. 3 shows a cross-section of A-A′ of FIG. 1;

FIG. 4 shows a finishing member and an upper cover according to an embodiment of the present disclosure; FIG. 5 shows a support member and an upper cover according to an embodiment of the present disclosure;

FIG. 6 shows a side binding member according to an embodiment of the present disclosure;

FIG. 7 shows a cross-section of C-C′ of FIG. 1;

FIG. 8 shows a front-rear binding member according to an embodiment of the present disclosure; and

FIG. 9 is an exploded view of a battery case and an outer binding member according to an embodiment of the present disclosure.

The drawings described herein are for illustration purposes only and are not intended to limit the scope of the present disclosure in any way.

### DETAILED DESCRIPTION

Hereinafter, some embodiments of the present disclosure are described in detail with reference to the accompanying drawings. Regardless of figure symbols, the same component or similar components are given the same reference numeral and a redundant description has been omitted.

In addition, a detailed description of related well-known techniques has been omitted if it obscures the subject matter of the embodiment disclosed herein. In addition, the accompanying drawings are provided only to aid in the understanding of the embodiments disclosed in the present specification, and it should be understood that the technical spirit disclosed herein is not limited by the accompanying drawings and all changes, equivalents, and substitutes included in the spirit and scope of the present disclosure are included.

Although ordinal numbers such as “first”, “second”, and they are used to describe various components of the present disclosure, those components are not limited by the terms. These terms may be used for the purpose of distinguishing one component from another component.

Singular forms include plural forms unless apparently indicated otherwise contextually. When a component, device, element, or the like of the present disclosure is described as having a purpose or performing an operation, function, or the like, the component, device, or element should be considered herein as being “configured to” meet that purpose or to perform that operation or function.

It should be further understood that the terms “comprises” and/or “has,” when used in this specification, specify the presence of a stated feature, number, step, operation, component, element, or combination thereof, but do not preclude the presence or addition of one or more other features, numbers, steps, operations, components, elements, or combinations thereof.

When a component is referred to as being “connected” or “accessed” to or by any other component, it should be understood that the component may be directly connected or accessed by the other component, but another new component may also be interposed between them. Contrarily, when a component is referred to as being “directly connected” or “directly joined” to or by any other component, it should be understood that there is no component between the component and the other component.

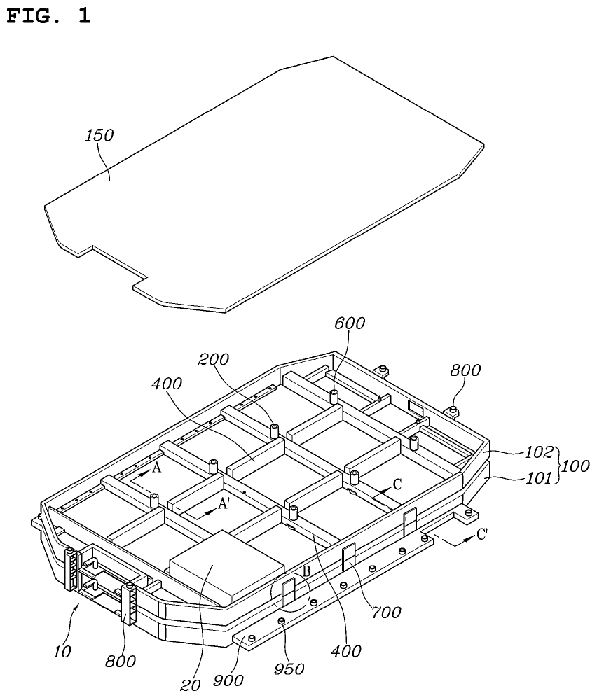

FIG. 1 is a stackable battery according to an embodiment of the present disclosure.

The stackable battery 10 according to an embodiment of the present disclosure may increase a battery capacity by vertically stacking a battery case 100 including a battery module. There is no limit in the number of battery cases 100 that are stackable, and the number of stackable battery cases 100 may change with a design of a vehicle or an energy storage system (ESS).

While the number of stackable battery cases 100 is not limited according to the purpose of the present disclosure, when necessary, for convenience of a description, in the description of the present disclosure and the proposed drawings, the present disclosure is described with an embodiment where two battery cases 100 are stacked. In this configuration, a battery case positioned in a relatively lower portion is referred to as a first battery case 101 and a battery case positioned in a relatively upper portion is referred to as a second battery case 102.

In one embodiment of the present disclosure, the stackable battery may include a plurality of battery cases 101, 102 (collectively “100”) each including a battery module therein and stacked in a height direction of a vehicle. The stackable battery further includes a plurality of through-pipes 200 provided in each battery case 100 and allowing the battery cases 100 to pass therethrough in a vertical direction. The through-pipes 200 are in the shape of pipes extending in the vertical direction inside the battery case 100, the through-pipes 200 are provided in each battery case 100 being penetrated together by being arranged together in the vertical direction, and a plurality of support members 300 respectively pass through the plurality of through-pipes 200 arranged in the vertical direction and support the upper battery case 100.

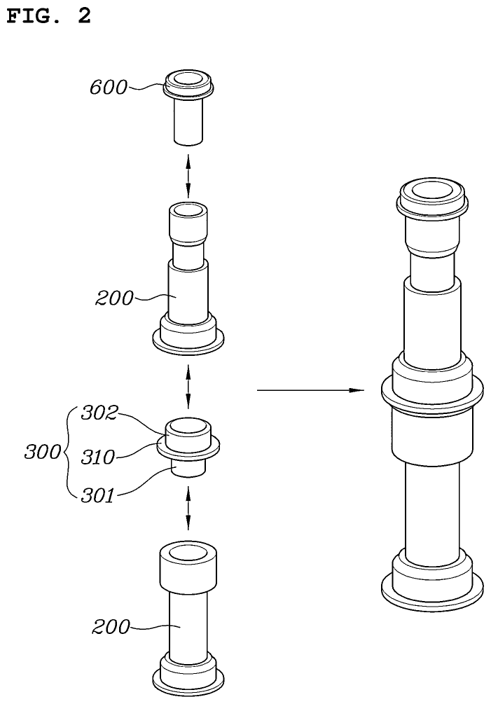

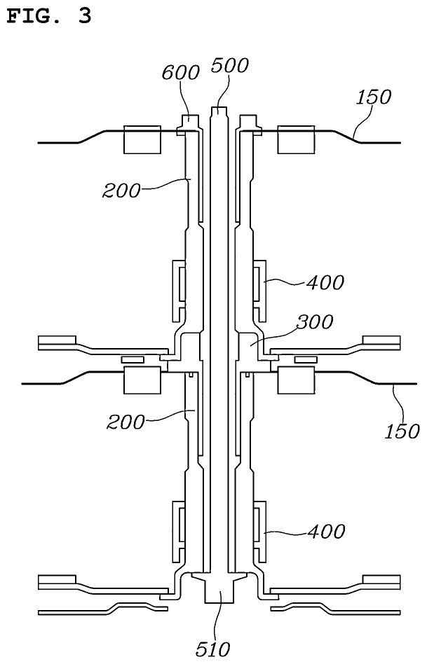

FIG. 2 shows assembly of a through-pipe 200, a support member 300, etc., and FIG. 3 shows a cross-section of A-A′ of FIG. 1.

Referring to FIGS. 1 to 3, each of the plurality of battery cases 100 may include a battery module. In the battery case 100, a wire connecting the battery module to the battery module, a wire connecting the battery module to a battery managing system (BMS), etc., are included. Moreover, a cooling system for cooling the battery module may be included inside the battery case 100. The battery case 100 may not only receive the foregoing components, but also protect the received components from a physical impact and vibration and block introduction of a foreign substance.

Because the battery case 100 including a battery module 20, etc., therein is very heavy, a structure for assisting the load of the battery case 100 stacked in an upper portion by the battery case 100 stacked in a lower portion is required to stably stack the battery cases 100.

To allow the battery case 100 in the lower portion to support the load of the battery case 100 in the upper portion (i.e., the upper battery case 100 stacked on the lower battery case), the support member 300 may be provided between the battery cases 100 to enable stable stacking.

More specifically, the plurality of through-pipes 200 may be provided in each of the first battery case 101 and the second battery case 102, and the plurality of through-pipes 200 may be provided at the same position of the first battery case 101 and the second battery case 102 such that when the first battery case 101 and the second battery case 102 are stacked, the through-pipes 200 provided in each of them may be arranged in a vertical direction.

The through-pipe 200 may have a circular pipe shape and have a hollow at a center thereof such that a support member 300 may be coupled to a top surface or a bottom surface of the through-pipe 200. As the support member 300 is provided, the battery case 100 positioned in the lower portion may support the load of the battery case 100 positioned in the upper portion.

The through-pipe 200 and the support member 300 may be positioned inside the battery case 100 to support the load of the battery case 100 positioned in the upper portion and at the same time, the binding force of the plurality of battery cases 100 may be increased for a strong binding force.

The through-pipe 200 and the support member 300 may be coupled by insertion or may be coupled with a spiral thread formed in each of them by rotation. In one embodiment, a spiral thread may be formed in a lower end 301 of the support member 300 and coupled to the through-pipe 200 by rotation and an upper end 302 of the support member 300 may be formed to have a shape and a width similar to those of a hollow of the through-pipe 200 and may be coupled by insertion.

With a combination of such components, a stackable battery with an increased battery capacity may be provided and such a stackable battery with an increased battery capacity may be mounted on an electric vehicle to remarkably increase a driving distance and provide psychological stability to a driver, and the a drivable distance with a single charge may be increased, thereby providing various options for long-distance driving.

Meanwhile, a member 400 having a closed cross-section may be provided inside the plurality of battery cases 100. The member 400 may divide an inner space having the battery module therein, and divide the inner space across the inner space in the transverse or longitudinal direction.

The member 400 may divide the inner space and at the same time, the mechanical rigidity of the battery case 100 may be improved. In other words, when the physical impact is applied to the battery case in the transverse or longitudinal direction across the inner space in the transverse or longitudinal direction, the impact may also be applied to member 400 and may be distributed to the plurality of members 400, thereby suppressing severe deformation of the battery case 100 and applying a relatively small impact to the battery module, in spite of a large physical impact.

The through-pipe 200 may be provided to be inserted into the member 400 provided inside the battery case 100. The through-pipe 200 may be provided to be inserted at a position at which the members 400 provided in the transverse direction or the members 400 provided in the longitudinal direction, or the members 400 provided in the transverse direction and in the longitudinal direction overlap each other. The through-pipe 200 and the member 400 may be coupled through welding, and MIG welding may be used as a welding method. Welding between the through-pipe 200 and the member 400 may suppress degradation of mechanical rigidity of the battery case 100 due to insertion of the through-pipe 200.

The support member 300 may also be inserted into the through-pipe 200 inserted into the member 400, thus being deformed a little in spite of transmission of the load thereto.

Meanwhile, referring to FIGS. 2 and 3, the overall shape of the support member 300 is a pipe shape extending in the vertical direction and extending in a circumferential direction at a point of the support member 300. A surface extending in the circumferential direction may form a seating surface 310 on which an upper end surface or a lower end surface of the through-pipe is seated. In other words, an upper end surface of the through-pipe 200 positioned relatively low may contact a bottom portion of the seating surface 310 and a lower end surface of the through-pipe 200 positioned relatively above may contact a top portion of the seating surface 310.

As such, the seating surface 310 may be formed, thereby giving more stability to stacking of the battery cases 100.

While the support member 300 has a pipe shape extending in the vertical direction, with respect to the seating surface 310, a width of an upper end portion 302 of the support member 300 may be formed to be the same as a width of a lower end portion 301. On the other hand, the width of the upper end portion 302 of the support member 300 may be formed to be different from the width of the lower end portion 301. The width of the upper end portion 302 and the width of the lower end portion 301 of the support member 300 may be determined according to widths of hollows formed in an upper end and a lower end of the through-pipe 200.

Meanwhile, the stackable battery according to the present disclosure may further include an engaging member 500 for engaging the battery cases 100. The engaging member 500 may be, for example, a bolt where a spiral thread is formed, and as the engaging member 500 binds the plurality of battery cases 100 through the plurality of through-pipe 200 and the support member 300, the stability of the stackable battery may be increased.

Meanwhile, the engaging member 500 may be inserted from the bottom and a head 510 of the engaging member 500 may be formed to have a width greater than that of the hollow formed in the through-pipe to allow the head 510 of the engaging member 500 to be seated on the bottom surface of the through-pipe 200 positioned at the bottom.

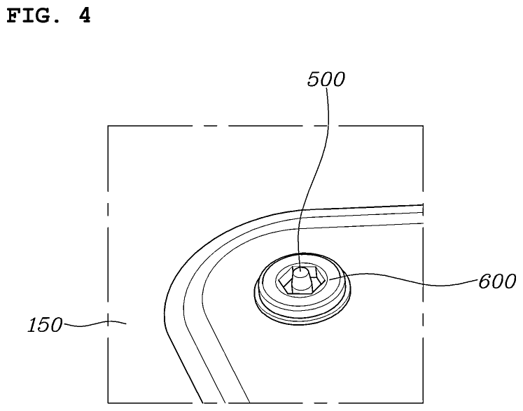

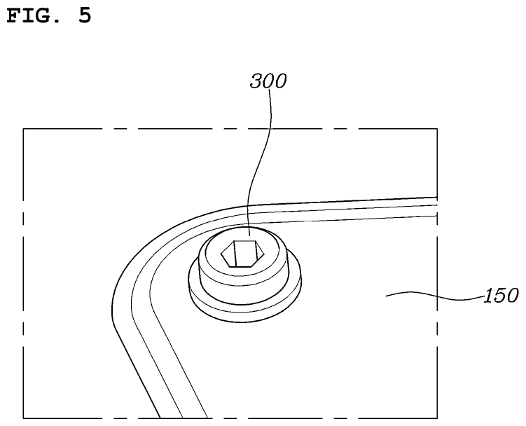

Referring to FIGS. 3 and 4, the stackable battery according to the present disclosure may further include a finishing member 600 coupled to the engaging member 500 that is inserted into the through-pipe 200. An upper cover 150 for preventing a foreign substance to be introduced into the battery case 100 may be installed and then the finishing member 600 may be coupled to the engaging member 500 to fix the upper cover 150, or the finishing member 600 may be coupled to the through-pipe 200 positioned at the top to allow the finishing member 600 to surround the engaging member 500.

Meanwhile, referring to FIG. 5, the upper cover 150 for preventing introduction of a foreign substance into the battery case 100 may also be installed at a lower end of the support member 300, and then the support member 300 may be coupled to the through-pipe 200 to fix the upper cover 150.

To bind the plurality of battery cases 100 at an inner side and support the upper battery case 100, the through-pipe 200 and the support member 300 may be provided. The stackable battery may include a component for binding the plurality of battery cases 100 at an outer side, a side binding member 700 may be provided on a side surface of the plurality of battery cases 100, and a front-rear binding member 800 may be provided on a front surface and a rear surface of the plurality of battery cases 100.

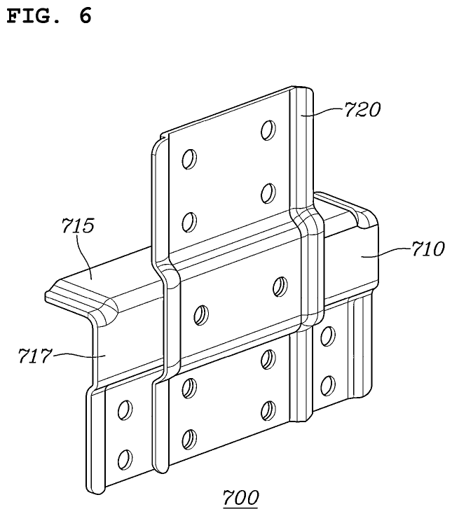

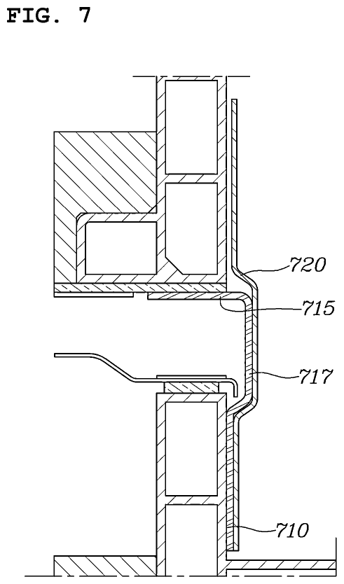

More specifically, referring to FIGS. 6 and 7, the side binding member 700 may include a first binding member 710 and a second binding member 720. In the first binding member 710, an inserting surface 715 with a surface extending in the width direction of the battery case 100 inserted between the plurality of battery cases 100 adjacent up and down may be formed, and a bent surface 717 may be formed to be bent downward at an end of the inserting surface 715 such that the bent surface 717 may contact a side surface of the battery case 100 positioned below. A second binding member 720 may have a shape extending up and down and a surface thereof may surround the bent surface 717 on an outer surface of the first binding member 710 and the other surface thereof may contact a side surface of the battery case 100 positioned on the inserting surface 715 of the first binding member 710.

The side binding member 700 may have a hollow formed therein and an engaging means such as a bolt may pass through the hollow to couple the first binding member 710 and the second binding member 720 to the plurality of battery cases 100.

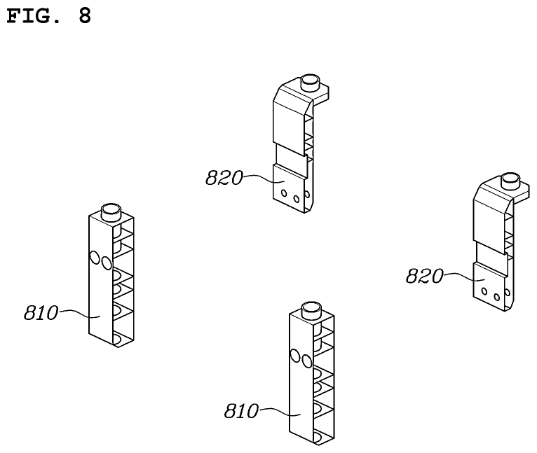

Meanwhile, referring to FIGS. 1 and 8, the front-rear binding member 800 may be coupled to a front surface and a rear surface of the plurality of battery cases 100, and the front-rear binding member 800 may include a front binding member 810 coupled to the front surface of the plurality of battery cases 100 and a rear binding member 820 coupled to the rear surface of the plurality of battery cases 100.

In each of the front binding member 810 and the rear binding member 820, a hollow may be formed and the engaging means such as a bolt may pass through the hollow, such that the front engaging member 810 and the rear binding member 820 may be coupled to the plurality of battery cases 100 to improve stability of the stackable battery.

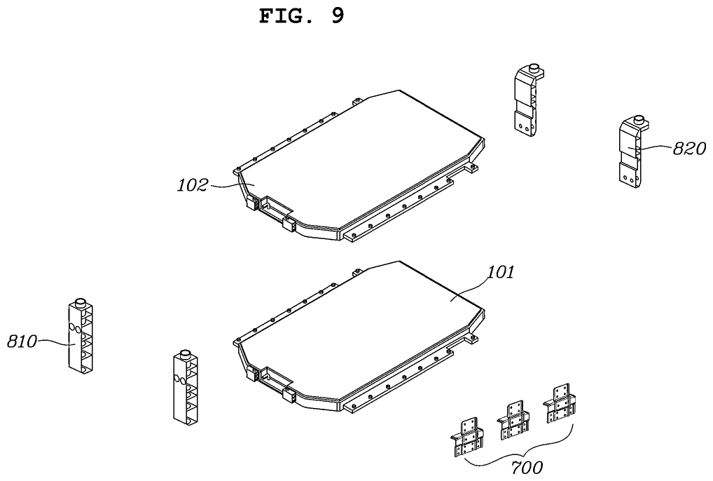

Referring to FIGS. 1 to 9, by increasing a binding force of the battery case where the plurality of side binding members and the plurality of front-rear binding members are stacked on the outer side of the plurality of battery cases, the stability of the stackable battery may be improved, and the binding force of the stacked battery cases may be improved through the through-pipe and the support member inside, thereby enhancing the stability of the stackable battery.

In this way, the stability of the stackable battery may be improved by binding of the outer side of the battery cases 100 through the side binding member 700 and the front-rear binding member 800.

Meanwhile, a mounting portion 950 for coupling the vehicle body and the battery case 100 may be formed on the outer surface of the battery case 100 provided at the bottom among the plurality of battery cases 100.

An electric vehicle having mounted thereon a battery may be designed for stability of driving such that the center of gravity is positioned on a lower frame of the vehicle body. Thus, the battery may be usually installed in the lower frame of the vehicle body. When the battery is installed in the lower frame of the vehicle body, the center of gravity is lowered and at the same time, battery replacement may be facilitated. That is, the battery is loaded and bolted from bottom to top of the lower frame of the vehicle body, such that in replacement of the battery, the vehicle may be lifted, bolting may be released, and a new battery may be coupled to the lower frame of the vehicle body.

For this reason, the mounting portion 950 for coupling the vehicle body and the battery case 100 may be formed in the battery case 100 provided at the bottom. On the outer surface of the battery case 100 positioned at the bottom, a side member 900 extending in the length direction of the battery case 100 may be provided and the mounting portion 950 may be provided in the side member 900.

Referring to FIG. 1, the side member 900 may be provided in the first battery case 101, and the mounting portion 950 may be provided in the side member 900 of the first battery case 101.

While the present disclosure has been shown and described in relation to specific embodiments thereof, it would be obvious to those of ordinary skill in the art that the present disclosure can be variously improved and changed without departing from the spirit of the present disclosure provided by the following claims.

### DESCRIPTION OF REFERENCE NUMERALS

| | |
|---|---|
| 100: battery case | 200: through-pipe |
| 300: support member | 400: member |
| 500: engaging member | 600: finishing member |
| 700: side binding member | 800: front-rear binding member |
| 900: side member | 950: mounting portion |

What is claimed is:

1. A stackable battery comprising:
a plurality of battery cases, each comprising a battery module therein, wherein battery cases of the plurality of battery cases are configured to be stacked on one another in a height direction of a vehicle;
a plurality of through-pipes provided in each battery case and configured to pass through the battery cases in a vertical direction, wherein the plurality of through-pipes is provided in each battery case and arranged together in the vertical direction; and
at least one support member configured to pass through a corresponding through-pipe among the plurality of through-pipes in the vertical direction and configured to support an upper battery case among the plurality of battery cases.

2. The stackable battery of claim 1, further comprising: a member configured to divide an inner space accommodating a battery module therein and configured to cross the inner space, wherein the member is provided in the plurality of battery cases, and a through-pipe among the plurality of through-pipes is inserted into the member and provided in a corresponding battery case among the plurality of battery cases.

3. The stackable battery of claim 1, wherein the at least one support member has a shape of a pipe extending in the vertical direction and comprises, at a point thereof, a seating surface extending in a circumferential direction on which an upper end surface or a lower end surface of the through-pipe is seated.

4. The stackable battery of claim 1, further comprising:
an engaging member configured to engage the plurality of battery cases by passing through the plurality of through-pipes and the at least one support member; and
a finishing bolt inserted from an upper end of a through-pipe provided on top, among the plurality of through-pipes, and coupled to the engaging member.

5. The stackable battery of claim 1, wherein a mounting portion for coupling a vehicle body with the battery case is formed on an outer surface of a battery case provided at bottom among the plurality of battery cases.

6. The stackable battery of claim 1, further comprising:
a side binding member attached to a side surface of the plurality of battery cases to bind the plurality of battery cases; and
a front-rear binding member attached to a front surface and a rear surface of the plurality of battery cases to bind the plurality of battery cases.

7. The stackable battery of claim 6, wherein the side binding member comprises:
a first binding member having formed therein an inserting surface with a surface extending in a width direction of the battery case, the inserting surface inserted between adjacent battery cases among the plurality of battery cases, and a bent surface formed to be bent downward at an end of the inserting surface, the bent surface contacting a side surface of the battery case; and
a second binding member having a shape extending in the vertical direction and having a surface surrounding a bent surface on a side surface of the first binding member and another surface contacting a side surface of the battery case positioned on the insertion surface.

8. The stackable battery of claim 6, wherein the front-rear binding member comprises a front binding member coupled to a front surface of the plurality of battery cases and a rear binding member coupled to a rear surface of the plurality of battery cases.

9. The stackable battery of claim 1, wherein the plurality of battery cases comprises a first battery case positioned in a relatively lower portion and a second battery case positioned in a relatively upper portion.
